(19) United States
(12) Patent Application Publication
(10) Pub. No.: US 2022/0099463 A1
(43) Pub. Date: Mar. 31, 2022

(54) System and Method for Contact-less Multi-Turn Absolute Position Sensing

(71) Applicant: Rockwell Automation Technologies, Inc., Mayfield Heights, OH (US)

(72) Inventors: Robert H. Schmidt, Mequon, WI (US); Chetan Chandrasekara, Chanhassen, MN (US); Daniel H. Serviss, Bloomington, MN (US); Jeffrey W. Dujmovic, Milwaukee, WI (US); Gennadi Sizov, Mequon, WI (US)

(21) Appl. No.: 17/038,877

(22) Filed: Sep. 30, 2020

(51) Int. Cl. G01D 5/20; G01D 5/26; G01D 5/245; G01D 5/165; G01P 3/487

(52) U.S. Cl. CPC G01D 5/2046; G01D 5/26; G01P 3/487; G01D 5/165; G01D 5/2458

(57) ABSTRACT

An encoder for detecting angular position of a rotor in a motor includes a modular hub, configured to be connected to the rotor, and sensing electronics mounted within an end bell of the motor. The modular hub provides a universal mounting configuration for connecting different configurations of the encoder to the motor. The modular hub includes a mounting portion and sensor face on which different elements for sensing may be mounted. The elements may include polarizing tape to reflect polarized light, magnets generating a magnetic field, or ferrous teeth configured to interact with a magnetic field. The sensing electronics include sensing devices corresponding to the elements mounted on the sensor face. The sensing devices may be a paired light emitter/receiver, magnetic sensors, or a paired magnetic field generator/sensor. The sensing electronics convert the sensed signals to uniform feedback data for the motor controller regardless of the encoder configuration.

### BACKGROUND INFORMATION

The subject matter disclosed herein relates to a contact-less, multi-turn absolute encoder for a motor and, more specifically, to an encoder with a mechanical assembly configured to be mounted to a rotatable shaft of a motor, the encoder including a sensor mounted within an end bell of the motor, the sensor including a contact-less interface with the mechanical assembly to detect an absolute, angular position of the rotatable shaft.

Rotation sensors including encoders, resolvers and the like, are electromechanical devices providing an electrical output corresponding to an angular position of a rotatable shaft. The mechanical portion of the device is configured to rotate and is physically constructed such that the rotation may be monitored. An optical sensor may include a disk-shaped rotor coupled to the shaft, the rotor having an optically readable pattern marked on its surface and the pattern formed by alternating opaque and transmissive frames. These frames are illuminated from one side by an emissive light source and the emitted light is either blocked by the opaque frames or passed through the transmissive frames of the rotor, with the light passing through the rotor reaching one or more stationary photodetectors. Rotation of the encoder shaft moves the disk-shaped rotor which, in turn, causes a fluctuation in the light transmitted through the transmissive frames of the rotor and reaching the photodetectors. Another common type of rotation sensor includes a magnet or a series of magnets mounted directly to the rotating encoder shaft or on a disk-shaped rotor coupled to the shaft within the encoder. Rotation of the encoder shaft causes a rotating magnetic field within the encoder. A sensor head is positioned proximate the rotating magnets to detect the changing magnetic field as the encoder shaft or rotor rotates. The electrical portion of the encoder is configured to generate one or more signals corresponding to the rotation of the mechanical portion. The photodetectors detect the light passing through the transmissive frames of an optical encoder or the sensor head detects the rotating magnetic field of a magnetic encoder. In each exemplary encoder, the sensors convert the optical light received or the magnetic field detected to an electrical signal, or signals, corresponding to the angular position of the rotating shaft.

Encoders may be classified as absolute or incremental encoders. The electrical signals produced by incremental encoders provide information only on the change in position of the sensor shaft. The signals may be sinusoidal or a series of pulses which are periodically repeated throughout one revolution of the rotating shaft. The encoder may generate a pair of signals offset by ninety degrees (i.e., in quadrature) which further allow for detection of the direction of rotation. Optionally, an incremental encoder may also include a separate track configured to generate a pulse once per rotation at a particular angular position on the rotor. In contrast, absolute encoders produce a unique value for each sensor position. The rotor of an optical absolute encoder may carry a series of concentric tracks, where each track includes either transmissive frames or magnets, configured to generate a binary coded value indicative of shaft position. Each track provides the value of one bit of the binary code and each track is read by a separate sensor to produce an output digital word.

Encoders are widely used in motion control applications. Accurate knowledge of the angular position of the motor is required in many motor control algorithms for successful operation of the motor. The electromechanical device requires both a mechanical coupling and an electrical coupling in the motion control system. The mechanical coupling is made between a rotating shaft on the motor and the rotating shaft on the encoder. The electrical coupling is made between the sensor head and its associated electronic components and a motor controller connected to the motor. Such connections are not met without certain challenges. Different encoder manufacturers design encoders with different physical constructions. A motor must be configured to accept mounting of different types of encoders from different manufacturers according to the encoder selected by the end user.

Similarly, the different encoder manufacturers design different encoders with different electrical connections. In some applications, the encoder may further include a communication interface by which data is transmitted from the encoder to the motor controller. The communication interface receives the signals generated by the photodetectors or the sensor head and converts these signals to a pulse count or other value that may be represented as a digital value. The digital value may be packaged into a data packet for transmission via a communication protocol to a motor controller. The motor controllers must be configured to accept different electrical signals or different communication protocols according to the encoder selected by the end user.

Thus, it would be desirable to provide an improved system and method for angular position sensing in a motion control application.

It would be desirable to provide an encoder with a universal mounting configuration for connection to the motor.

It would also be desirable to provide an encoder with a common communication interface for receiving angular position information from different configurations of the encoder.

### BRIEF DESCRIPTION

According to one embodiment of the invention, a modular encoder for absolute position sensing in a motor includes a hub and a sensing module. The hub includes a central hub portion configured to mount to a rotor of the motor, a sensor face connected to the central hub portion, and at least one set of passive sensing elements mounted to the sensor face. The sensor face is configured to receive multiple different sets of passive sensing elements. The sensing module is mechanically and electrically isolated from the hub. The sensing module includes a substrate configured to be mounted within an end bell of the motor and multiple active sensing elements mounted to the substrate. Each of the active sensing elements is configured to generate a position feedback signal responsive to detecting one of the plurality of passive sensing elements.

According to another embodiment of the invention, a method of determining an absolute position of a motor with a modular encoder is disclosed. One of multiple hubs is mounted to a rotor of the motor. Each of the hubs includes a central hub portion configured to mount to the rotor, a sensor face connected to the central hub portion, and at least one set of passive sensing elements mounted to the sensor face. The sensor face is configured to receive multiple different sets of passive sensing elements. A sensing module is mounted within an end bell of the motor, where the sensing module is mechanically and electrically isolated from the hub. The sensing module includes a substrate and multiple active sensing elements mounted to the substrate, and each of the active sensing elements is configured to generate a position feedback signal responsive to detecting one of the passive sensing elements. The position feedback signal from at least one of the plurality of active sensing elements is sampled to determine the absolute position of the motor.

According to still another embodiment of the invention, an encoder for absolute position sensing in a motor includes a hub, multiple active sensing elements, and a processor. The hub includes a central hub portion configured to mount to a rotor of the motor, a sensor face connected to the central hub portion, and at least one set of passive sensing elements mounted to the sensor face. The sensor face is configured to receive multiple different sets of passive sensing elements. The active sensing elements are mounted within an end bell of the motor. Each of the active sensing elements is mechanically and electrically isolated from the hub and is configured to generate a position feedback signal responsive to detecting one of the plurality of passive sensing elements. The processor is configured to control operation of the motor, sample the position feedback signal from each of the plurality of active sensing elements, and determine an absolute position of the motor.

These and other advantages and features of the invention will become apparent to those skilled in the art from the detailed description and the accompanying drawings. It should be understood, however, that the detailed description and accompanying drawings, while indicating preferred embodiments of the present invention, are given by way of illustration and not of limitation. Many changes and modifications may be made within the scope of the present invention without departing from the spirit thereof, and the invention includes all such modifications.

### BRIEF DESCRIPTION OF THE DRAWINGS

Various exemplary embodiments of the subject matter disclosed herein are illustrated in the accompanying drawings in which like reference numerals represent like parts throughout, and in which:

FIG. 1 is a schematic representation of an exemplary motion application illustrating one embodiment of contact-less position sensing in a motor;

FIG. 2 is a partial block diagram representation of the embodiment of contact-less position sensing in the motor as shown in FIG. 1;

FIG. 3 is a schematic representation of an exemplary motion application illustrating another embodiment of contact-less position sensing in a motor;

FIG. 4 is a partial block diagram representation of the embodiment of contact-less position sensing in the motor as shown in FIG. 3;

FIG. 5 is a timing diagram of one embodiment of communication between a motor controller and a motor according to the exemplary motion application of FIG. 1;

FIG. 6 is a timing diagram of another embodiment of communication between a motor controller and a motor according to the exemplary motion application of FIG. 1;

FIG. 7 is a sectional view of one embodiment of a hub mounted to a rotor and a communication module mounted within an end bell of a motor;

FIG. 8 is a sectional view of one embodiment of a hub mounted to a rotor;

FIG. 9 is a partial perspective view of keying elements on one end of hub and on a rotor to align the hub in a desired orientation on the hub;

FIG. 10 is a first modular hub according to one embodiment of the invention;

FIG. 11 is a second modular hub according to one embodiment of the invention;

FIG. 12 is a third modular hub according to one embodiment of the invention;

FIG. 13 is a fourth modular hub according to one embodiment of the invention;

FIG. 14 is a fifth modular hub according to one embodiment of the invention;

FIG. 15 is a sixth modular hub according to one embodiment of the invention; and

FIG. 16 is an exemplary bead and track in a multi turn absolute position sensing chip.

In describing the various embodiments of the invention which are illustrated in the drawings, specific terminology will be resorted to for the sake of clarity. However, it is not intended that the invention be limited to the specific terms so selected and it is understood that each specific term includes all technical equivalents which operate in a similar manner to accomplish a similar purpose. For example, the word “connected,” “attached,” or terms similar thereto are often used. They are not limited to direct connection but include connection through other elements where such connection is recognized as being equivalent by those skilled in the art.

### DETAILED DESCRIPTION

The various features and advantageous details of the subject matter disclosed herein are explained more fully with reference to the non-limiting embodiments described in detail in the following description.

The subject matter disclosed herein describes an improved system and method for angular position sensing in a motor control application. The encoder includes a modular hub configured to be connected to a rotor of a motor. The modular hub provides a universal mounting configuration for connecting different configurations of the encoder to the motor. The modular hub includes a central hub portion configured to directly connect to the rotor. The central hub portion is mechanically configured to mount to the rotor in a single orientation. The mechanical configuration may include, for example, a keyed member extending from the central hub portion, where the keyed member is configured to engage a recess on the rotor to establish a desired orientation of the modular hub with respect to the rotor. Optionally, the central hub portion may include a recessed region having a unique interior cross-section and the end of the rotor shaft may include a section with a corresponding external cross-section, such that the central hub portion may only fit on the rotor shaft in a predefined orientation. A fastener, such as a threaded fastener, may extend through a threaded channel extending along a central axis of the hub portion and into a threaded channel on the end of the rotor shaft to rigidly couple the modular hub to the rotor of the motor.

The modular hub further includes a sensor face located on the surface of the modular hub facing away from the motor. According to one embodiment of the invention, the sensor face may have an exterior diameter that is generally the same diameter as the central hub portion. According to another embodiment of the invention, the sensor face may have a diameter greater than the diameter of the central hub portion and be located, on a sensor disc which is located at the end of the modular hub furthest from the motor. The sensor disc may be integrally formed with the central hub portion, for example, as a single cast member or the sensor disc may be joined to the central hub portion during manufacture by welding, by a fastener, by heating the sensor disc and sliding onto the central hub portion, or by any other suitable joining method. According to still other aspects of the invention, a portion of the sensor disc may be integrally formed with the central hub portion and other portions of the sensor disc mounted to thereto.

The sensor disc may include different elements for sensing, thereby allowing for different configurations of the encoder. According to one embodiment of the invention, the sensor disc may include a pair of magnets, each magnet having an opposite polarity mounted to the sensor face. According to another embodiment of the invention, the sensor disc may include a series of teeth either integrally formed or mounted to the sensor face. Optionally, the sensor teeth may be positioned around an outer periphery of the sensor face. The modular encoder may provide sensor discs having a varying number of sensor teeth and/or a varying number of rings of sensor teeth arranged on the sensor face or outer periphery of the sensor face according to a desired level of accuracy in determining angular position of the motor shaft. According to still another embodiment of the invention, the sensing face may include a polarizing surface, such as polarizing tape, applied to the sensing face. The polarizing tape may be mounted to the surface such that incident light, emitted from a light source, reflects off the tape and returns to a photosensor in a desired plane for detection. The polarizing tape may further be configured to reflect the incident light in two portions, where a second portion is phase-shifted from the first portion such that the receiving electronics may generate a sine and cosine signal. According to still another embodiment of the invention, the sensor disc may include a combination of the above-recited sensing elements, such as including both polarizing tape and a pair of magnets or including both a pair of magnets and a series of teeth located on the sensor face. Each modular hub is configured to be mounted to the rotor in the same manner regardless of the configuration of the sensor disc, allowing for the modular hub to be exchanged with another hub if a different configuration of the encoder is desired.

The encoder also includes sensing electronics mounted within an end bell of the motor and proximate to the modular hub in order to determine angular position of the rotor from the sensing elements mounted on the sensor face of the modular hub. The electronics may be mounted on a dedicated circuit board or, optionally, may be mounted to another circuit board, such as a power circuit board for an integrated motor drive, configured to be mounted within the motor. The sensing electronics include sensing devices corresponding to the sensing elements selected for the modular hub. The sensing devices may be magnetic sensors configured to detect the magnets mounted on the sensor face. Optionally, the sensing devices may include both a generating device and a sensing device. To detect teeth mounted to the sensing face, the teeth may be made of a ferrous material and the generating device establishes a magnetic field through which the teeth pass. A sensing device detects the change in the magnetic field and generates signals corresponding to the teeth passing through the magnetic field. To detect light from the polarizing surface, a generating device may be included which emits light toward the polarizing surface, and a receiving device is configured to detect the polarized light reflected from the polarized surface. The sensing electronics are configured to provide a uniform interface to the motor controller with the sensed angular position of the rotor regardless of the selected sensing elements and sensing devices in the encoder. Thus, the sensing electronics provide an encoder with a common communication interface for receiving angular position information from different configurations of the encoder.

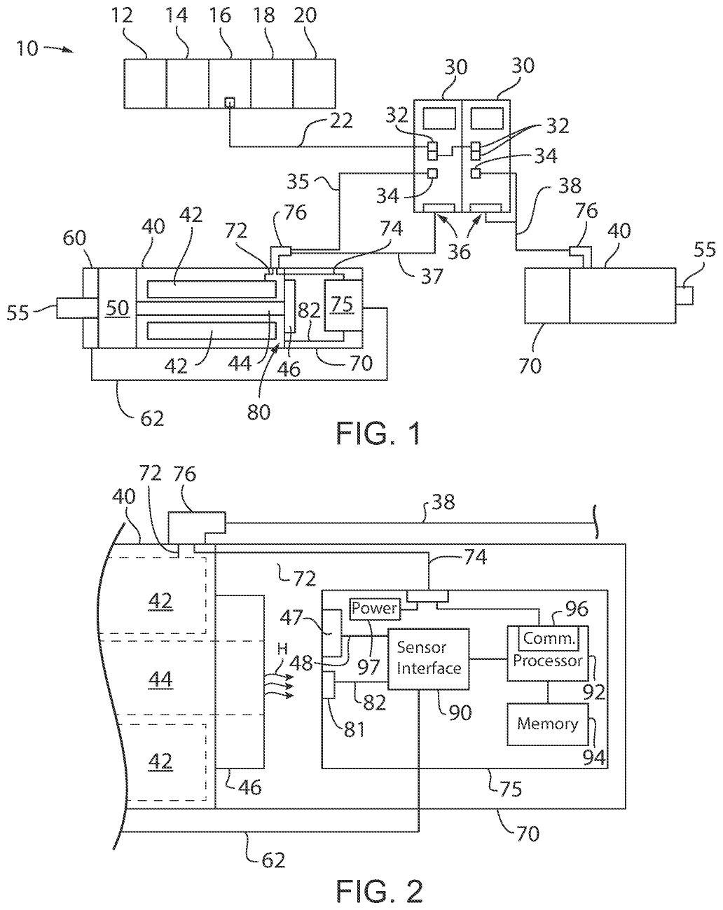

Turning initially to FIG. 1, an exemplary industrial controller 10 is provided to control operation of an industrial machine or process. The illustrated industrial controller 10 includes a power supply module 12, a processor module 14, a communication module 16, an input module 18 and an output module 20. It is understood that the industrial controller 10 may include numerous different configurations. An industrial controller may include a rack or multiple racks in which modules are inserted. A backplane may extend along a rack for communication between modules and an industrial network may be configured for communication between remote racks or other devices within the controlled machine or process. Still other industrial controllers may include a fixed configuration, having a predefined processor, communication interface, inputs, and outputs. The illustrated industrial controller 10 is intended to be exemplary and not limiting.

The processor module 14 is configured to execute a control program or a series of different programs, in series, in parallel, or a combination thereof to achieve desired operation of the controlled machine or process. Motion in the controlled machine or process may be achieved by controlling operation of one or more motors 40 with a motor drive 30, also referred to herein as a motor controller. Each motor drive 30 and the corresponding motor 40 to be controlled by the motor drive 30 are sometimes referred to as an axis of motion. The control program executing in the processor module 14 may be configured to generate motion commands to achieve the desired operation of the machine or process. Optionally, one or more dedicated motion modules may be included in the industrial controller 10 to generate the motion commands. These motion commands are, in turn, transmitted to the motor controller 30.

According to the illustrated embodiment, a network cable 22 is connected between the communication module 16 and the motor controller 30 across which the motion command may be transmitted. Optionally, the network cable 22 may be connected directly to the processor module 14, or the network cable 22 may be connected to a motion module included in the industrial controller 10. Each motor controller 30 includes at least one network communication port 32. According to the illustrated embodiment, each motor controller 30 includes a pair of communication ports 32 such that multiple motor controllers 30 may be connected in a daisy-chain configuration. A first communication port 32 on a first motor controller 30 is connected to the communication module 16, and a second communication port 32 on the first motor controller 30 is connected to a first communication port 32 on a second motor controller 30. Still additional motor controllers 30 could be connected in a similar manner from the second communication port 32 of the second motor controller 30.

Each motor controller 30 is operatively connected to a motor 40 and is configured to control operation of the connected motor. According to one embodiment of the invention, a pair of cables 35, 37 may extend between the motor controller 30 and the motor 40. A first cable 35 may be utilized for communication between the motor controller 30 and the motor 40. The first cable 35 is connected between a motor communication port 34 on the motor controller 30 and connector 76 on the motor 40. Within the motor 40, internal communication conductors 74 extend between the connector 76 and a communication module 75 mounted within an end bell 70 of the motor 40. The internal conductors 74 may be wires, a cable, traces on a circuit board, or a combination thereof. The second cable 37 may be utilized for supplying power to the stator 42 of the motor 40. The second cable 37 is connected between output terminals 36 on the motor controller 30 and the connector 76 on the motor 40. Internal motor conductors 72 extend between the connector 76 and the stator 42 to provide voltage to control rotation of the motor 40.

According to another embodiment of the invention, a single cable 38 may extend between the motor controller 30 and the motor 40. The single cable 38 may be configured to provide both power and supply communication between the motor controller 30 and the motor 40. According to the illustrated embodiment, one end of the single cable 38 includes a first connector configured to plug into the motor communication port 34 and a second connector configured to connect to the output terminals 36. Optionally, the motor controller 30 may be configured to have a single connector or a set of terminals positioned next to each other to which the single cable 38 may be connected.

Each motor 40 includes a stator 42 and a rotor 44. In many applications, it is desirable for the motor controller 30 to have knowledge of an angular position of the rotor 44. An encoder 46 may be mounted to one side of the rotor 44, where the encoder 46 is configured to generate a position feedback signal 48 corresponding to the angular position of the rotor 44. The other end of the rotor 44 is connected to a drive assembly 50 by which the controlled machine or process operates. Optionally, the encoder 46 may include passive and active components. The passive components may be, for example, a pair of magnets mounted to the end of the rotor 44 and the active components may include a sensor mounted to the communication module 75, where the sensor generates a position feedback signal corresponding to rotation of the magnets. Optionally, the passive components may be a series of teeth milled on or otherwise mounted to a surface which is, in turn, mounted to the end of the rotor 44. The active components may include a magnet and a magnetic field sensor mounted on the communication module 75. The magnet generates a magnetic field which is intersected by the teeth rotating through the field. As the teeth rotate, the magnetic flux tends to follow the teeth as they pass through the magnetic field and the magnetic field sensor is positioned within the magnetic field such that it detects the variation in the magnetic flux.

It is contemplated that the drive assembly 50 may be a gearbox, a pulley, a drive chain, a ball screw, other drive members, or a combination thereof by which a desired motion in the controlled machine or process is obtained as a result of rotation of the rotor 44 within the motor 40. In certain applications, such as robotic motion, it may be desirable to provide a second encoder 60 at the output of the drive assembly 50 where the second encoder 60 may be operatively connected to an output drive member 55 from the drive assembly 50. The second encoder 60 may be used to verify an angular position of an end effector or tool located at the output of the drive assembly 50 and the second encoder 60 provides a second position feedback signal 62.

It is further contemplated that the motor 40 may include still additional devices mounted on or proximate to the motor, where the additional device generate signals corresponding to operation of the motor 40, the drive assembly 50, or of other aspects of the controlled machine or process. It is contemplated that the additional devices may be sensors configured to measure, for example, temperature, angular acceleration, vibration, orientation, proximity, a level, an open or closed contact, and the like. According to the embodiment illustrated in FIG. 1, a temperature sensor 80 is mounted in the body of the motor, where the temperature sensor is configured to generate a temperature feedback signal 82. According to the embodiment illustrated in FIG. 2, a non-contact temperature sensor 81, such as an infrared sensor, may be provided to detect heat, H, radiated from the motor 40. The non-contact temperature sensor 81 is similarly configured to generate a temperature feedback signal 82. The non-contact temperature sensor 81 may be mounted on the substrate 77 for the communication module 75 in different locations according to a desired temperature to be measured. Further, multiple non-contact temperature sensors 81 may be mounted on the substrate 77 to measure temperature at multiple locations, where each sensor 81 is configured to generate a temperature feedback signal 82. According to one aspect of the invention, the non-contact temperature sensor 81 may be mounted proximate to the center of the rotor to monitor the motor shaft temperature. According to another aspect of the invention, the non-contact temperature sensor 81 may be mounted proximate to or beyond an outer diameter of the rotor 44 to measure a temperature of a bearing for the rotor 44. Still other non-contact temperature sensors 81 may be provided, for example, at a location where a magnet mounted to the hub passes by the sensor 81 and the feedback signal 82 may be used to infer a temperature of the magnet. Each of the feedback signals, including the position feedback signal 48, the second position feedback signal 62, the temperature feedback signal 82, or any other feedback signals generated by other devices mounted on or proximate to the motor 40 are provided to the communication module 75 for subsequent transmission back to the motor controller 30.

Turning next to FIG. 2, the communication module 75 includes a sensor interface 90 configured to receive each of the feedback signals provided to the communication module. The sensor interface 90 may include, for example, buffers to temporarily store values of the feedback signals or analog-to-digital converters to convert an analog feedback signal to a digital feedback signal. The sensor interface 90 includes circuitry and components to receive and process the feedback signals to a suitable form for the processor 92. The processor 92 is in communication with memory 94 and is configured to execute a series of instructions stored in the memory 94. The processor 92 may be a single processor, multiple processors, or multiple processing cores arranged on a single device. The processor 92 may be configured to execute a single series of instructions or multiple series of instructions asynchronously, synchronously, in series, or in tandem. The memory 94 may be a single device or multiple devices and includes at least a portion of non-volatile memory.

The communication module 75 also includes a communication interface 96 for managing communication with the motor controller 30. According to one embodiment of the invention, the communication interface 96 is an Ethernet interface. Similarly, the communication port 34 on the motor controller 30 is an Ethernet port. If the network between the industrial controller 10 and the motor controller 30 is similarly an Ethernet network, or an industrial Ethernet network, data packets may be transmitted between the communication module 75 on the motor 40 and the motor controller 30 or between the communication module 75 and other devices, such as the industrial controller 10, connected to the network. The communication interface 96 may be an integral component of the processor 92 or, optionally, a separate communication interface 96 may be arranged on a common printed circuit (PC) substrate to which the interface 96 and processor 92 may be mounted. The communication interface 96 is configured to transmit and receive data packets over the network according to the protocol of the network, where the protocol is preferably an industrial network protocol, such as Ethernet/IP®, DeviceNet®, ControlNet®, or CompoNet®.

Typically, a motor controller 30 has served as a final node in an industrial network. Position feedback data or data from other sensors/devices mounted on or proximate to the motor 40 are first transmitted to the motor controller 30 and then may be transmitted over the network. Similarly, if a sensor is, for example, a smart sensor with the ability to be remotely configured, the motor controller 30 must be configured to first receive the configuration packet and then a communication interface between the motor controller 30 and the sensor must be established to pass on the configuration data. Operating in such a capacity, however, places extra demands on the motor controller 30. The motor controller 30 must be configured with additional inputs and outputs configured to receive or send signals with the devices mounted on or proximate to the motor 40. Similarly, a portion of the processing bandwidth in the motor controller is required to serve as a gateway to receive the data feedback signals, package these signals into data packets, and transmit them to the industrial controller 10. Dedicated wiring between each device and the motor controller 30 is also required. As the number of devices located on or proximate to the motor 40 increases, the number of conductors required increases, increasing the physical space required for wiring, reducing the flexibility of bundled wires, and increasing the potential for a wiring error to occur.

Inclusion of the communication module 75 in the motor 40 reduces the processing demands placed on the motor controller 30 and simplifies wiring between the motor 40 and the motor controller 30. The communication module 75 receives the feedback signals from the devices at the sensor interface 90 and converts the feedback signals to digital values suitable for use in a digital processor. The processor 92 in the communication module 75 may transmit a data packet to the motor controller 30 if the feedback signal, such as angular position of the motor, is intended for the motor controller 30 or may transmit the data packet back to the industrial controller 10 if the feedback signal, is needed for the control program executing in the processor module 14 of the industrial controller. Wiring between the motor controller 30 and the motor 40 may be reduced to the pair of cables 35, 37 or even to a single cable 38 as shown in FIG. 1. In one embodiment of the invention, the communication cable 35 or the portion of the single cable 38 configured for communication may be a single-pair Ethernet cable, including just two conductors. The power cable 37 or the portion of the single cable 38 configured to conduct power includes four conductors, where three conductors supply the voltage for each of the three phases of the motor and the fourth conductor is a ground conductor. The total necessary conductors, therefore, may be limited to just six conductors. To prevent the need for any additional conductors, the control power for the communication module 75 may also be supplied over the single-pair Ethernet cable. As shown in FIG. 2, the internal conductors 74 connected to the external single-pair Ethernet conductors may be divided on the PC substrate to deliver control power to a power section 97 and the data packet to the communication interface 96.

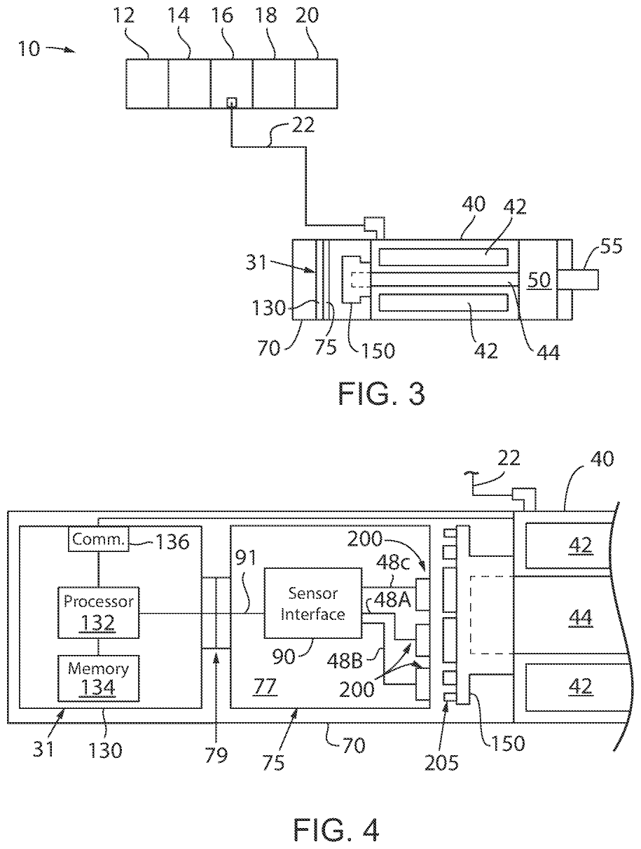

Turning next to FIG. 3, another embodiment of a motor controller 31 configured to control operation of the motor 40 is illustrated. The motor controller 31 of this embodiment is configured to be distributed around the controlled machine or process, rather than located in a control cabinet. The distributed motor controller 31 may be mounted to the motor 40 and may include a separate housing for the distributed motor controller 31 or may be included within a housing of the end bell 70 for the motor 40 as shown. Each distributed motor controller 31 is configured to receive the motion commands from the industrial controller 10 via the network cable 22 in a manner similar to that discussed above. The distributed motor controller 31 includes a communication port 136 and may include multiple communication ports, providing for daisy chain communication with another distributed motor controller 31 in a manner similar to the motor controllers 30 discussed above.

With reference also to FIG. 4, the distributed motor controller 31 includes a PC substrate 130 on which a processor 132 and memory 134 are mounted. It is contemplated that the motor controller 31 may be on a separate PC substrate 130 from the communication module 75. Optionally, the communication module 75 may be mounted to the PC substrate 130 for the motor controller 31, for example, as a daughter board to via a connector 79 mounted on the PC substrate 130. According to still another embodiment of the invention, the communication module 75 may be integrated onto the PC substrate for the motor controller 31 such that a single circuit board is mounted within the end bell 70 of the motor 40. The processor 132 is in communication with the memory 134 to execute a series of instructions to control operation of the motor 40. The instructions include control routines configured to receive the motion commands, regulate position, velocity, current, and/or torque within the distributed motor controller 31 and to control gating signals according to desired operation of the motor 40 to deliver the correct magnitude and frequency of voltage and/or current to the stator 42 of the motor 40 via the power conductors 72.

As discussed above, many applications require the motor controller 31 to have knowledge of an angular position of the rotor 44. According to the illustrated embodiment, a modular sensing hub 150 is mounted to one end of the rotor 44. Sensing electronics 200 mounted on the PC substrate for the communication module 75 are configured to detect passive elements 205 mounted on the modular sensing hub 150 to determine an angular position of the rotor 44. According to one embodiment of the invention, the sensing electronics 200 generate multiple position feedback signals 48A-48C, where the multiple signals may be used together to determine an absolute angular position of the rotor 44. According to another aspect of the invention, the multiple position feedback signals 48A-48C may be used together to maintain knowledge of the absolute angular position of the rotor over multiple turns even through loss of control power to the communication module 75. Operation of the sensing electronics 200 and the modular hub 150 will be presented in more detail below.

According to one embodiment of the invention, the communication module 75 may be configured in a manner identical to that discussed above with respect to a motor controller 30 mounted remotely from the motor 40. According to another embodiment of the invention, a portion of the electronic devices and/or functions performed on the communication module 75 may be included in the distributed motor controller 31. Because the distributed motor controller 31 includes a processor 132, the position feedback signal 48 may be passed directly from the sensor interface to the processor 132 via a feedback signal line 91. It is contemplated that the sensor interface circuit 90 may, for example, be implemented in whole or in part on an application specific integrated circuit (ASIC) or on a field programmable gate array (FPGA). Some processing functions may incorporated into the sensor interface circuit 90 to manage data transfer between the sensor interface circuit 90 and the processor 132 in the distributed motor controller 31. However, the sensor interface circuit 90 may be configured to transmit raw position feedback signals 48 directly to the processor 132 in the embedded motor controller 31 and the embedded motor controller 31 may sample the position feedback signals as needed to control operation of the motor 40. In other embodiments, the sensor interface circuit 90 may sample the position feedback signals 48 and pass the sampled data to the motor controller 31. If the distributed motor controller 31 is included within a housing of the end bell for the motor 40, it is contemplated that the substrate 77 for the communication module 75 and the substrate 130 for the distributed motor controller 31 may be the same substrate or, optionally, one substrate 77 may be mounted as an accessory board to the other substrate 130.

In a motion application, precise control of the motor 40 requires that the motor controller 30 receives the angular position of the motor 40. In addition to receiving the angular position, the motor controller 30 must obtain the sampled value at precise intervals and, preferably, at a consistent time during the interval (i.e., without jitter). A control algorithm executing within the motor controller 30 similarly executes at the same interval as the angular position is sampled or at multiples of the interval. Therefore, the motor controller 30 must coordinate with the communication module 75 to obtain the angular position at a desired time interval. This coordination must occur between a remote motor controller 30 and the communication module 75 but must also occur with a distributed motor controller 31 if the sensor interface circuit 90 is performing sampling of the position feedback signals 48. Although discussed below with respect to a remote motor controller 30, the synchronization may equally apply to a distributed motor controller 31 when the sensor interface circuit 90 samples position feedback signals 48 rather than passing the feedback signals directly to the distributed motor controller 31.

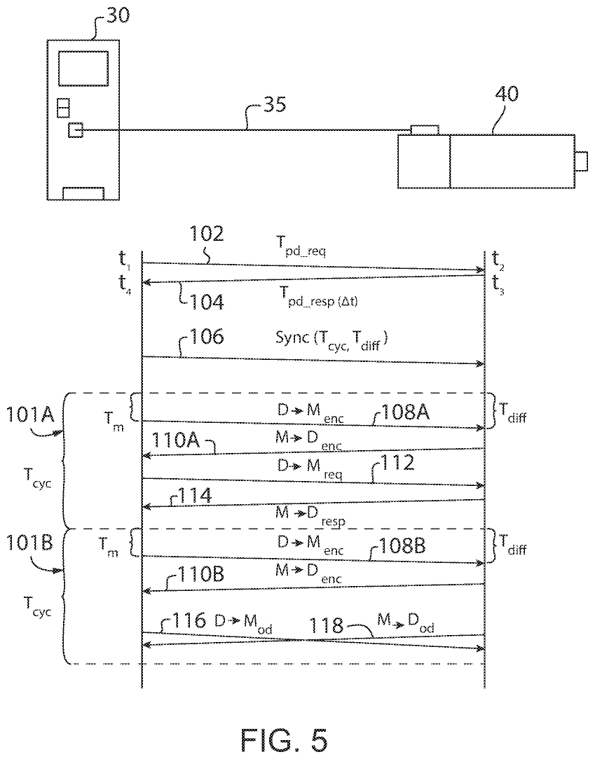

Turning next to FIG. 5, a timing diagram for establishing communication between the motor controller 30 and the motor 40 is illustrated. Three data packets are transmitted between the motor controller 30 and the communication module 75 in the motor 40 to establish synchronous periodic execution between the motor controller 30 and the communication module 75. An initial data packet 102, T_{pd_req}, is transmitted from the motor controller 30 to the motor 40 at time, t₁. The initial data packet 102 may be time-stamped in the motor controller 30 upon transmission and the motor controller 30 stores the value of the first time, t₁, in memory. The data packet 102 is also time-stamped at the communication module 75 upon receipt at time, t₂. The second time, t₂, may be stored in memory 94 on the communication module 75. The communication module 75 generates a responsive data packet 104, T_{pd_resp}, which is sent back to the motor controller 30 at a third time, t₃. The communication module 75 may be configured to transmit the responsive data packet 104 at a predefined time interval after receiving the initial request data packet 102. Alternately, the communication module may measure the time between the second time, t₂, and the third time, t₃. Either the predefined time or the measured duration between receiving the initial data packet 102 at the second time, t₂, and sending the responsive data packet 104 at the third time, t₃, is defined as the delay time, Δₜ, within the communication module. This delay time, Δₜ, is transmitted to the motor controller 30 in order to determine the path delay time. Finally, the responsive data packet 104 is received by the motor controller 30 at a fourth time, t₄. Receipt of the responsive data packet 104 is timestamped and the first time, fourth time, and delay time are utilized as shown below in Equation 1 to determine a one-way transmission delay, T_{pd}, between the motor controller 30 and the communication module 75.

T_{pd}=t₄−t₁−Δt)/2 (1)

The motor controller 30 utilizes the value of the one-way transmission delay, T_{pd}, to determine a compensation time, T_{diff}, for the communication module 75. This compensation time, T_{diff}, is equal to a packet start time, Tₘ, added to the one-way transmission delay, T_{pd}, determined in the initial steps. The packet start time corresponds to an expected duration from the start of the periodic cycle to a time within the periodic cycle that the motor controller 30 will transmit a data packet to the communication module 75. Adding the packet start time, Tₘ, to the transmission delay, Δt, determines a total expected time between the start of a periodic cycle and the reception of the data packet at the communication module 75. The motor controller 30 then generates a synchronize message packet 106, Sync, which includes the total cycle time, T_{cyc}, for the periodic cycle as configured within the motor controller 30 and the compensation time, T_{diff}, for the communication module 75.

After receiving the total cycle time, T_{cyc}, for the periodic cycle and the compensation time, T_{diff}, the motor controller 30 and the communication module 75 may begin synchronized communications. As shown in FIG. 5, two cycles 101 of communication between the motor controller 30 and the communication module 75 are illustrated. In each cycle 101, the motor controller 30 sends a packet 108 requesting a value of the angular position of the motor 40, and the communication module 75 responds with a packet 110 which includes the angular position of the motor 40. After processing the request and response for the angular position of the motor 40, additional data packets may be transmitted for additional data transfer between the motor controller 30 and the motor 40.

Turning initially to the first communication cycle 101A, the motor controller 30, acting as the master device for synchronization, transmits the angular position request packet 108A at the packet start time, Tₘ. The angular position request packet 108A is received at the communication module 75 in the motor 40 after a duration equal to the transmission delay, Δt, from when the packet is sent. This total time, as previously indicated, is equal to the compensation time, T_{diff}, for the communication module 75. The communication module 75, having the total cycle time, T_{cyc}, for the periodic cycle and the compensation time, T_{diff}, knows how much time is left in the present cycle and when the next cycle is to begin. The communication module 75 may then begin maintaining a periodic cycle that is synchronous with the periodic cycle in the motor controller 30. Consequently, the length of the periodic cycle may be adjusted within the motor controller 30 and the corresponding periodic cycle in the communication module 75 is synchronized to the periodic cycle in the motor controller 30 after retransmitting the synchronization data packets.

Upon receiving the angular position request packet 108A, the communication module 75 builds an angular position response packet 110A and stores a present value of the angular position in the packet. The communication module 75 then transmits this angular position response packet 110A back to the motor controller 30. Additionally, for every periodic cycle 101 subsequent to the initial periodic cycle, the communication module 75 obtains a value of the angular position of the motor 40 from the encoder 46 at the start of the next periodic cycle. In this manner, the motor controller 30 may execute a control algorithm to control operation of the motor 40 with the expectation that the angular position is sampled at the start of each periodic cycle. Optionally, it may be desirable to sample the angular position twice during a periodic cycle. After initially synchronizing the two periodic cycles of the motor controller 30 and the communication module 75, the communication module may similarly sample the angular position of the motor, for example, at the start of each period and at the midpoint of each period. The motor controller 30 may send a single read request to which the communication module 75 sends a response containing two sampled values or the motor controller 30 may send a pair of read requests to which the communication module 75 sends a response to each request, where each response includes a single sampled value. In this manner, the motor controller 30 and the communication module 75 work together to ensure that the angular position is sampled at precise intervals and at a consistent time during the interval. Because the motor controller 30 requires these angular position values at precise intervals, the first portion of each cycle may be reserved for transmission of the angular position request and response packets 108A, 110A. A second portion of each cycle may be allocated to other communications between the motor controller 30 and the motor 40.

According to another aspect of the invention, it is contemplated that other data in addition to the angular position of the motor may need to be sent within the first portion of each cycle. In one application, the second encoder 60 may be mounted to provide a check on the first encoder 46 or to verify operation of the mechanical drive train. The angular position from the second encoder 60 may similarly be sampled at the start of each cycle and both angular position values may be packaged into the angular response packet 110 and transmitted to the motor controller 30. In another application, it may be desirable for the motor controller 30 to have data from one or more of the sensors mounted proximate to the motor at the same frequency as the angular position of the motor. A vibration sensor, for example, may be mounted to the motor and generate a feedback signal corresponding to vibration measured on the motor 40. The value of the vibration feedback signal may be packaged within the angular response packet 110 and transmitted to the motor controller 30 in tandem with the angular position. It is contemplated that the data to be sent in the angular response packet 110 is configurable within the motor controller 30 and the motor controller 30 can send an initial configuration packet, for example, during power up or during a commissioning process to configure the communication module accordingly to transmit the desired data at the periodic frequency during the first portion of the cycle 101.

According to still another aspect of the invention, it is contemplated that data may be transmitted to the communication module 75 from the motor controller 30 within the angular position request packet 108. The motor controller 30 may, for example, control operation of a brake on the motor 40 via serial communication. It may be desirable to transmit a command signal to the motor 40 at the same periodic interval at which the angular position data is requested. The angular position request packet 108 may include a status bit or status work within the data packet in which a command signal for the brake is provided. The status bit may be set to a logical one when the motor controller 30 wants the brake open and to a logical zero when the motor controller 30 wants the brake set. A feedback signal from a sensor indicating whether the brake is open or closed may generate a binary feedback signal and a status bit or status word may similarly be included within the angular response packet 110 to provide the motor controller 30 with the current state of the brake. Optionally, the brake command and brake status signals may not be required as frequently and may be transmitted in an on-demand message as will be discussed next.

As discussed above, the communication module 75 is configured to receive feedback signals not only from the encoder 46 but also from other devices mounted on or proximate to the motor 40. The motor controller 30 and/or the industrial controller 10 periodically requires values of the feedback signals. However, the timing for obtaining values of the other feedback signals is typically not as critical and/or does not require as frequent updates. The motor controller 30, for example, may execute a routine which generates pulse-width modulation (PWM) signals to control operation of the motor 40 at a frequency in the range of two to twenty kilohertz (2-20 kHz) and some applications may require a PWM frequency even greater than twenty kilohertz. An exemplary application may require the PWM frequency to be set to ten kilohertz (10 kHz). The duration of each period is then one hundred microseconds (100 μsec). In contrast, the industrial controller 10 or the motor controller 30 may only require knowledge of other feedback signals every five or ten milliseconds (5-10 msec). These feedback signals may either be requested on-demand by the industrial controller 10 or motor controller 30 or scheduled for transmission within the communication module 75 at predefined intervals. It is further contemplated that the on-demand messages may be used for configuration messages on power-up, parameter configuration, and other messages that may be sent infrequently or only when needed.

With reference again to the first cycle 101A illustrated in FIG. 5, the motor controller 30 transmits on on-demand request message 112 to the communication module 75 after completion of the angular position messages and receives an on-demand response message 114 back. The motor controller 30 may be requesting, for example, a value of the temperature of the motor 40 as indicated by the temperature feedback signal 82 generated by a temperature sensor 80 or 81 in the motor 40. The motor controller 30 may be configured to generate an overtemperature message if the value of the temperature feedback signal 82 exceeds a predefined threshold as stored within the motor controller 30. One or more of the request and response messages 112, 114 may be transmitted according to the duration of the total period, T_{cyc}, allocated to on-demand messages.

Turning also to the second cycle 101B illustrated in FIG. 5, the on-demand messages may be scheduled to occur at a predefined time within the total period of each cycle. The angular position request and response packets 108B, 110B are again transmitted during the first portion of the total period of the cycle, T_{cyc}. At a predefined time within the period, both the motor controller 30 and the communication module 75 are configured to transmit data packets 116, 118 respectively. It is contemplated that these data packets may be, for example, a heartbeat data packet to verify continued communication, a synchronous data packet which may be periodically sent to indicate a present time in each controller and to allow subsequent correction for clock drift or other errors in the periodic cycle, or to transmit data at predefined intervals at the same frequency or at a reduced frequency from the PMW frequency of the motor controller 30. The motor controller 30 and/or the communication module may include a table defining both response/request messages or unidirectional data transfer messages and the frequency at which they need to be transmitted. These on-demand messages are then transmitted according to the stored schedule during the second portion of each cycle.

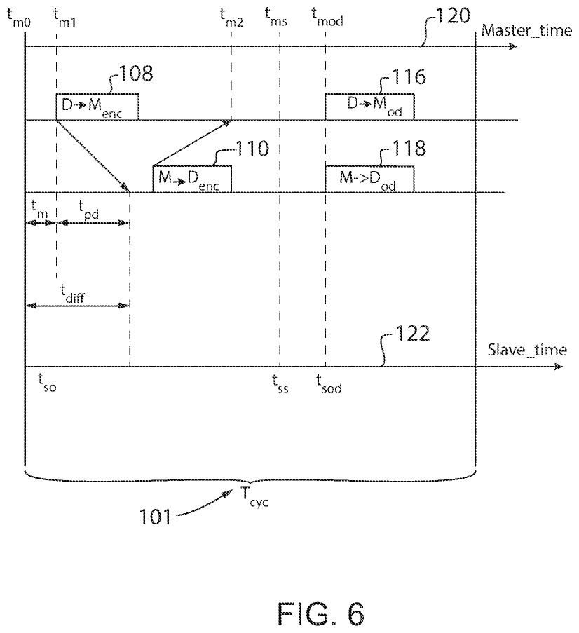

Turning next to FIG. 6, a second timing diagram, again illustrating transmission of information between the motor controller 30 and the communication module 75 is illustrated. Both the motor controller 30, acting as the master device, and the communication module 75, acting as the slave device, include independent clocks with a corresponding master time 120 and slave time 122, respectively. While the clocks may be synchronized, obtaining synchronous operation between the motor controller 30 and the communication module 75 in the motor 40 does not require that these clocks be synchronized. Rather, the initial synchronization messages 102-106 discussed above are transmitted between the devices to establish synchronous operation. When the communication module 75 receives an initial angular position request packet 108, the communication module 75 is aware of the total cycle time, T_{cyc}, and the compensation time, T_{diff}, previously sent from the motor controller 30. As a result, the communication module 75 may then begin execution of a synchronous periodic interval within the communication module 75 based on the slave time 122 rather than on the master time 120. At each subsequent cycle, the start of the cycle for the motor controller 30 is represented by the time, tₘ₀, and the start of the cycle for the communication module 75 is represented by the time, to, which, as illustrated, are coincident with each other. The motor controller 30 transmits the angular position request packet 108 at the packet start time, Tₘ, to the communication module 75. The angular position request packet 108 is transmitted within the duration of the transmission delay, Δt, and arrives at the communication module 75 at the compensation time, T_{diff}. The communication module 75, having established its own synchronized periodic cycle, samples the angular position at the start of the cycle, to, packages the sampled value in a data packet, and transmits the angular position response packet 110 to the motor controller 30. The angular position response packet 110 is received at the motor controller 30 at time, tₘ₂.

At a predefined interval within the cycle 101, both the motor controller 30 and the communication module 75 reach a synchronous time, tₘₛ and tₛₛ, respectively. It is contemplated that both the motor controller 30 and the communication module 75 may generate a pulse signal at this synchronous time. The pulse signal may be an internal signal within the motor controller 30 and the communication module 75. Optionally, the pulse signals may be provided as an output signal of each device for external observation, for example, by an oscilloscope or other external monitoring device. According to still another option, each pulse signal may be transmitted between devices and used to verify that each device is remaining in synchronous operation. In any event, the synchronous time occurs at a duration within the total cycle, T_{cyc}, that is sufficient for the angular position request and response packets 108, 110 to have completed transmission.

After the synchronous time, both the motor controller 30 and the communication module 75 enter the on-demand portion, t_{mod} and t_{sod}, respectively, of each cycle 101. It is contemplated that the on-demand time may coincide with or occur at some point within the cycle after the synchronous time, tₘₛ and tₛₛ. According to the cycle 101 illustrated in FIG. 6, both the motor controller 30 and the communication module 75 are configured to transmit an on-demand data packet 116 and 118, respectively, at the start of the on-demand portion, t_{mod} and t_{sod}, of the cycle.

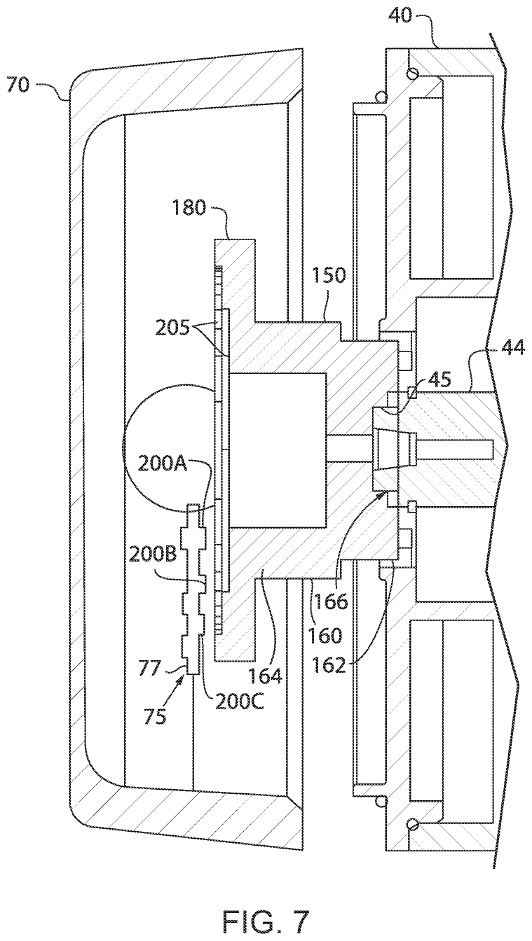

Turning next to FIG. 7, one embodiment of a hub 150 mounted to a rotor 44 of the motor 40 is illustrated along with a communication module 75 mounted within the end bell 70 of the motor 40 and proximate to the hub 150. Encoders have commonly been provided as a packaged unit within its own housing. An encoder shaft extends from the housing and is coupled to the rotor. The mechanical couplings, however, typically include a compliant mount compensating for minor mechanical misalignments between the encoder shaft and the rotor shaft and/or vibration occurring in the rotor 44. While the compliant mount may dampen vibration experienced at the encoder shaft, the housing may still experience vibration. In addition, capacitive coupling between the stator windings 42 and the rotor 44 may lead to some magnitude of voltage present on the rotor, also referred to as shaft voltage. The mechanical coupling of the encoder to the rotor may allow the shaft voltage to be conducted to and potentially damage the sensing electronics and/or bearings within the encoder. Thus, it is desirable to provide sensing electronics 200 physically and electrically isolated from the passive sensing elements 205 mounted on the hub 150.

The illustrated embodiment includes a communication module 75 mounted within the end bell 70 of the motor. Active sensing elements 200A-200C are mounted to a PC substrate 77 for the communication module 75. Each active sensing element is positioned on the substrate 77 at a location configured to detect a passive sensing element 205 mounted on the hub 150. As the rotor 44 rotates within the motor 40, the hub 150 similarly rotates causing the passive sensing elements 205 to pass the active sensing elements 200A-200C. The active sensing elements 200A-200C detect the rotation of the passive sensing elements 205 and generate a position feedback signal 48A-48C (see also FIG. 4) corresponding to the rotation of the passive sensing elements 205. The position feedback signals 48A-48C are used to determine and angular position of the rotor 44. Mounting the active sensing elements 200A-200C to the PC substrate 77 for the communication module 75 and, in turn, to the end bell 70 of the motor 40 provides both mechanical and electrical isolation from the hub 150 on which the passive sensing elements 205 are mounted.

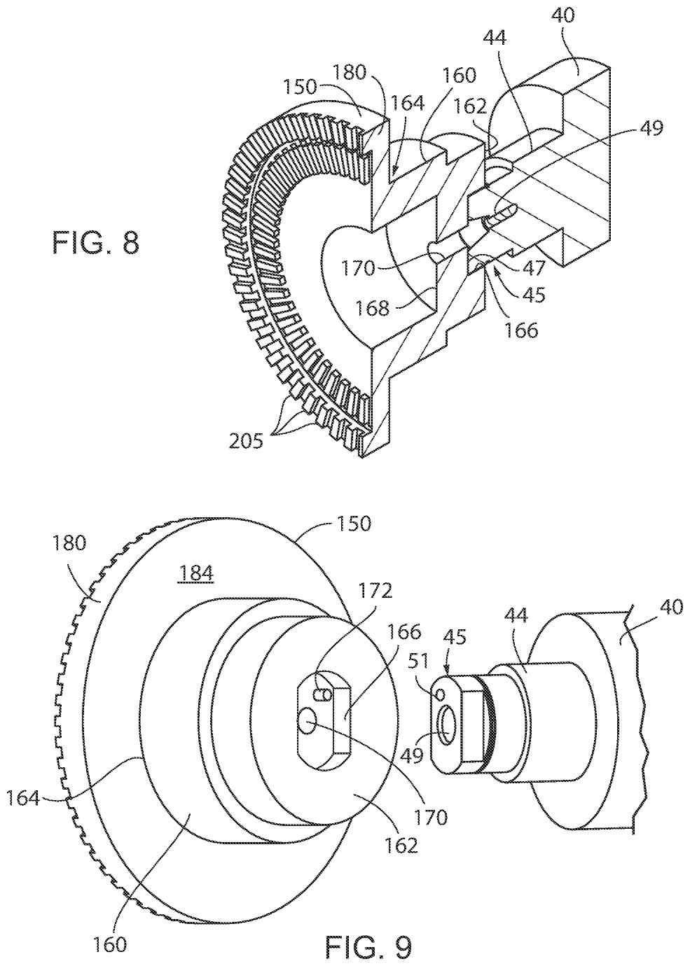

Turning next to FIG. 8, the hub 150 includes a central hub portion 160 and a sensor face 180. The central hub portion 160 is configured to mount to the rotor 44, and the sensor face 180 is configured to receive the passive sensing elements 205. The central hub portion 160 includes a first end 162 and a second end 164, the second end opposite the first end. The first end 162 is configured to receive a coupling portion 45 of the rotor 44, and the second end 164 is joined to the sensor face 180. The first end 162 includes an opening 166 having an inner periphery that is complementary to an outer periphery of the coupling portion 45 of the rotor. According to one embodiment of the invention, it is contemplated that the outer periphery of the coupling portion 45 of the rotor may be generally cylindrical. The inner periphery of the opening 166 may, therefore, be circular and configured to receive the cylindrical coupling portion. The central hub portion 160 includes a surface 168 within the opening 166 against which the coupling portion 45 of the rotor is seated. An opening 170 in the surface 168 is coaxial with the central hub portion 160 and aligns with a complementary opening 49 in the coupling portion 45. A threaded member, such as a bolt may extend through the opening 170 in the central hub portion 160 and engage a threaded inner periphery of the complementary opening 49 to retain the central hub portion 160 to the coupling portion 45 of the rotor. Optionally, other methods of joining the central hub portion 160 to the rotor 40, such as a press fit or the like, may be utilized. The complementary size of the opening 166 configured to receive the coupling portion 45 of the rotor, the rigid surface 168 against which the coupling portion 45 is seated, and the threaded member configured to positively retain the hub 150 to the rotor 44 establish a rigid coupling between the rotor 44 and the hub 150.

With reference also to FIG. 9, it is contemplated that the coupling portion 45 of the rotor 44 and the first end 162 of the hub 150 may each include keying elements configured to mount the hub 150 in a predefined alignment with the rotor 44. According to the illustrated embodiment, the coupling portion 45 of the rotor includes a recess 51 serving as a first keying element, and the first end 162 of the hub 150 includes a protrusion 172 serving as a second keying element. The protrusion 172 on the hub 150 has an outer diameter and a length that is complementary to an inner diameter and a depth of the recess 51 on the coupling portion. The inner diameter of the opening 166 on the central hub includes a first flat surface and a second flat surface, which correspond to similar flat surfaces on the coupling portion 45 of the rotor. While the flat surfaces would ensure that the hub 150 is mounted to the coupling portion 45 in just one of two orientations, the protrusion 172 and recess 51 further define a singular orientation by which the hub 150 may be mounted to the rotor 44. Similarly, the outer periphery of the coupling portion 45 may be have an asymmetrical shape. A complementary asymmetrical inner periphery of the opening 166 may be utilized to define a singular orientation by which the hub 150 is mounted to the rotor 44.

Ensuring that the hub 150 is mounted to the rotor 44 in a predefined orientation may allow the motor controller 30, 31 to start operation of the motor 40 without first executing a commutation orientation routine. In a permanent magnet motor, magnets are mounted to the rotor 44 to establish a constant magnet field in the motor. The voltage and current supplied to the stator 42 are varied to achieve desired operation of the motor 40. The magnets are configured to generate a magnetic field that approaches a sinusoidal waveform across one set of pole pairs within the motor. A sinusoidal voltage supplied to the stator 42 interacts with the magnetic field generated by the magnets to achieve a desired operation of the motor 40. However, the motor controller 30, 31 must know the angular orientation of the magnetic field generated by the permanent magnets for reliable operation of the motor 40. If the sinusoidal voltage applied to the stator 42 is at a phase angle that is offset from the magnetic field of the rotor, the motor 40 may experience a step change, or bump, at start during which the rotor jumps to align with the voltage applied to the stator. In some applications, the rotor may remain misaligned from the voltage applied to the stator and the torque production of the motor is reduced. In still other applications, the polarity of the magnetic field may oppose the polarity of the voltage applied to the stator, resulting in a run-away condition of the motor. In order to avoid the undesirable operation, the motor controller 30, 31 typically performs a commutation alignment routine prior to operation in order to determine the angular alignment of the magnetic field generated by the rotor.

As one aspect of the present invention, the keying elements, such as the recess 51 on the coupling portion 45 and the protrusion 172 on the hub allow the hub 150 to be assembled to the rotor 44 in a predefined orientation. The recess 51 on the hub is located on the coupling portion 45 of the rotor 44 in a known relationship with respect to the permanent magnets mounted to the rotor. Thus, the recess 51 will be located at a known angular position of the magnetic field generated by the magnets. Mounting the hub 150 to the coupling portion 45 of the rotor, therefore, with a complementary keying element, such as the protrusion 172, allows the hub 150 to mounted to the rotor in a known angular alignment. As will be discussed in more detail below, the passive sensing elements 205 may be mounted to the sensor face 180 in a manner to provide an absolute angular position of the rotor 44 to the motor controller 30, 31. The passive sensing elements 205 may, therefore, be mounted to the sensor face 180 in a manner to provide, at a minimum, a known position feedback value. Further, if the position feedback signal is a sinusoidal waveform, it may be desirable to orient the passive sensing elements 205 on the sensor face in an arrangement to provide a sinusoidal waveform that corresponds to the sinusoidal waveform of the magnetic field generated by the permanent magnets. As a result of the keying elements establishing a known angular orientation of the passive sensing elements 205 with respect to the magnetic field in the rotor 44, the motor controller 30, 31 may sample the position feedback signals 48 prior to starting operation of the motor 40 and know the angular alignment of the magnetic field without first executing a commutation alignment routine.

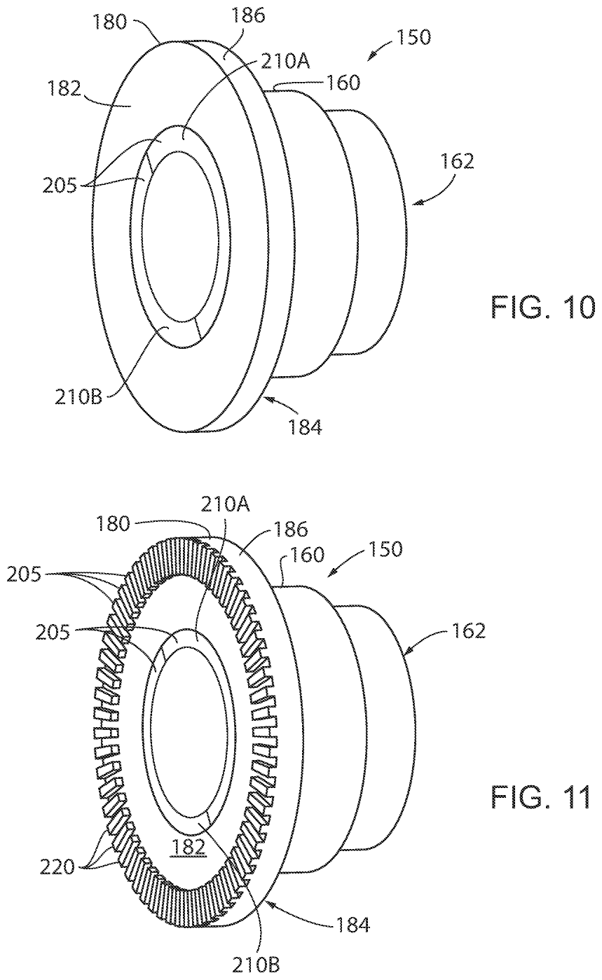

Turning next to FIGS. 10-14, the hub 150 may include a number of different passive sensing elements 205 mounted to the sensor face 180. The sensor face 180 includes a first surface 182 and a second surface 184, the second surface opposite the first surface. The first surface 182 is oriented away from the motor 40 when the hub 150 is mounted to the motor and is configured to receive the passive sensing elements 205. The second surface 184 is oriented toward the motor 40 when the hub 150 is mounted to the motor and joins the second end 164 of the central hub portion 160. It is contemplated that the sensor face 180 and the central hub portion 160 may be integrally formed as a single assembly. The sensor face 180 and the central hub portion 160 may, for example, be cast as a single metal assembly or machined from a single piece of stock. Optionally, the sensor face 180 may be made as a separate assembly and joined to the central hub portion by, for example, welding or heat fitting the ring onto the second end 164 of the central hub portion 160.

With reference to FIG. 10, a single pair of magnets 210 may be mounted to the first surface 182 of the sensor face 180. A first magnet 210A may be configured to have a positive polarity and a second magnet 210B may be configured to have a negative polarity. The magnets 210A, 210B may have a generally uniform thickness, as illustrated, or, optionally, may be shaped with each end tapered and the middle wider to create a stronger magnetic field toward the center of each magnet 210 and a weaker magnetic field toward each end of the magnet. Shaping the magnet 210 may produce a magnetic field having a more sinusoidal waveform over one rotation of the rotor 44. The magnets 210 may be mounted directly to the first surface 182 of the sensor face 180 or the first surface 182 may include a channel in which the magnets 210 are seated such that the surface of the magnets 210 are generally flush with the first surface 182 of the sensor face 180.

The magnets 210A, 210B work together with one or more of the active sensing elements 200 mounted on a PC substrate 77. The active sensing elements 200 are positioned proximate to the first surface 182 of the sensor face 180 such that the active sensing elements 200 may detect the magnetic field generated by the magnets 210A, 210B. According to one aspect of the invention, a first sensing element 200A is positioned adjacent to the magnets 210A, 210B as they rotate and may generate a low resolution position feedback signal 48 to the sensor interface circuit 90. It is contemplated that the position feedback signal 48 may be a simple high or low signal to indicate a positive or negative polarity of the magnet 210. Optionally, the sensing element 200A may be configured to generate a sinusoidal waveform corresponding to a single rotation of the rotor 44. The sensing interface circuit 90 may be configured to pass the position feedback signal 48 directly back to the motor drive 31 or it may first perform some initial processing on the feedback signal 48, for example, generating a series of pulses responsive to a difference in amplitude of the position feedback signal 48. The pulses may convert a sinusoidal signal 48 to a low resolution pulse train having, for example, up to sixteen bit resolution or 65,536 cycles per revolution.

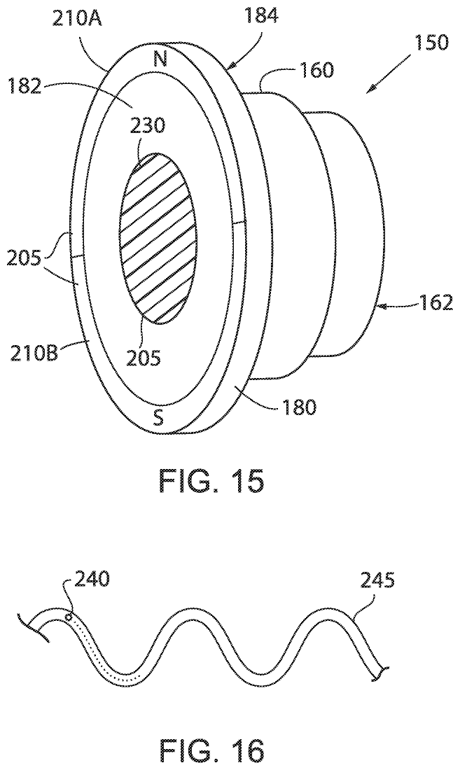

It is further contemplated that the magnets 210A, 210B may be configured to engage a second sensing element 200B. The second active sensing element 200B may be a multi-turn magnetic bead type chip mounted on the substrate 77. With reference also to FIG. 15, the magnetic bead chip may include a bead 240 which is driven by a magnetic force and a track 245 along which the bead 240 travels. The magnetic bead chip may be aligned across from the magnets 210 such that the magnetic bead 240 is attracted to one of the two polarities of magnets 210A, 210B. As the rotor 44 spins, the magnet 210 to which it is attracted draws it along the track 245 in one direction and, for example, pulls it down the slope of the track 245. The magnet 210 continues to attract the bead 240 for one half a revolution of the rotor 44 and drives the bead down the slope of the track 245 and at least partly around the bend at the bottom of the track. When the magnet 210 having a polarity which repels the bead 240 begins to pass the chip, the bead is driven up the slope of the track 245. The bead 240 continues up the slope and around the bend during the next half revolution as the magnet from which it is repelled pushes the bead 240 along the track 245. The cycle repeats as the magnet 210 having the first polarity again begins to attract the bead down the next slope of the track 245. It is contemplated that the track may have shapes other than sinusoidal including, but not limited to a saw-tooth waveform or a square waveform. It is also contemplated that a separate magnet or magnetic strip may be mounted to the first surface 182 of the sensor face 180, where the separate magnet or magnetic strip may be arranged to drive the bead 240 within the track 245. The separate magnetic strip may, for example, be positioned on the sensor face 180 in a non-concentric manner such that the magnetic strip passes back-and-forth past the track 245 as the hub 150 rotates. The magnetic strip moving back-and-forth past the track causes the magnetic bead 240 to move along the track 245.

The multi-turn magnetic bead chip 200B may be configured to generate a feedback signal 48B corresponding to a particular location along the track. The chip may, for example, generate an integral number corresponding to a number of cycles that the bead has driven along the track 245. The track 245 may include hundreds or thousands of cycles along the track. According to one embodiment of the invention, the processor 92 on the communication module 75 may be configured to monitor the output of the magnetic bead chip. In some configurations of the track 245, the bead 240 may be limited to travel the maximum number of cycles in one direction before the motor 40 must reverse direction and travel in the other direction, similarly driving the bead in the other direction. In other configurations of the track 245, the track may be continuous, returning the bead 240 to a starting location and again traveling along the length of the track 245. The chip may be configured to generate a signal indicating that the feedback signal 48B is reset upon the bead 240 returning to the start position. Optionally, the processor 92 on the communication module 75 or the processor 132 in a distributed motor controller 31 may be configured to detect the bead 240 returning to the start position and maintain a counter. The processor may use the counter and the present location of the bead 240 to maintain an expanded multi-turn absolute position of the motor 40.

It is also contemplated that the hub 150 may be configured to include multiple passive sensing elements 205. The embodiment of the hub 150 illustrated in FIG. 11 includes a first magnet 210A and a second magnet 210B mounted on the first surface 182 of the sensor face 180 in a manner discussed above with respect to FIG. 10. However, the hub 150 further includes a row of teeth 220 spaced around the outer periphery of the sensor face 180. According to the illustrated embodiment, the teeth 220 are uniformly shaped and uniformly spaced apart along the sensor face 180. The substrate 77 includes a third active sensing element 200C configured to detect the teeth 220 as the rotate past the sensing element. The active sensing element 200C may be include a magnet generating a magnetic field and a sensing element configured to detect the magnetic field. As the teeth rotate past the active sensing element 200C, the direction of the magnetic flux within the magnetic field follows the path of least magnetic resistance. In other words, the magnetic flux tends to pass from the magnet to the teeth 220 rather than pass through the air gap between teeth. As a tooth 220 passes the active sensing element 200C, the majority of the flux flows into the tooth 220 and returns to the magnet. The flux follows the tooth 220 past the magnet and then enters the next tooth rather than flowing into the air gap between the teeth 220. The magnetic sensor detects the motion of the magnetic flux and generates a signal corresponding to the teeth 220 passing the sensor. In one embodiment, the position feedback signal may be a series of digital pulses, signaling either the presence or absence of a tooth 220. The number of pulses is dependent on the number of teeth spaced around the perimeter and may be in a range, for example, of between eight bit and twenty bit resolution, generating between two hundred fifty-five and over one million pulses per revolution. In another embodiment, the teeth 220 may be shaped to have a sectional area other than a square or rectangle, as shown. Rather, the sectional area of each tooth 220 may be shaped such that the sensor outputs a sinusoidal signal corresponding to teeth 220 passing. The sinusoidal signal may be provided to the processor 92 on the communication module 75 or to the processor 132 in the distributed motor drive 31 and used to generate a higher resolution determination of the angular position of the motor 40. It is contemplated that the teeth 220 may be integrally formed with the sensor face 180, for example, via molding, casting, or machining. It is also contemplated that the teeth 220 may initially be mounted on or over-molded within a separate substrate. The separate substrate may be adhered, affixed, or mounted to the first surface 182 of the sensor face 180.

In still another embodiment of the invention, the teeth 220 may have an asymmetric construction, allowing the processor to determine velocity and/or relative acceleration of the motor. As indicated above, the active sensing elements 200 may include a magnet mounted to the communication module substrate 77, where the magnet generates a magnetic field that interacts with the teeth 220 on the sensor face 180. The magnet may be located on the rear of the substrate 77 and a stationary coil may be located on the front of the substrate 77 between the magnet and the sensor face 180. The stationary coil may be, for example, wire such as Litz wire, wound into a coil and mounted to the board. Optionally, the stationary coil may be a trace on the substrate 77. According to still another aspect of the invention, the stationary coil may be wound around the magnet or otherwise positioned within the magnetic field of the magnet. The stationary coil is positioned within the magnetic field such that it detects the varying air gap flux produced by the interaction of the magnetic field and the variable reluctance of the teeth 220 passing the stationary coil. The varying air gap flux will induce an emf voltage in the stationary coil. The emf voltage is a function of the number of turns in the coil, the strength of the magnetic field, and the angular velocity of the teeth 220 as they pass the coil. Because the number of turns in the coil and the strength of the magnetic field are known, the magnitude of the emf induced in the coil may be used to determine the angular velocity of the rotor.

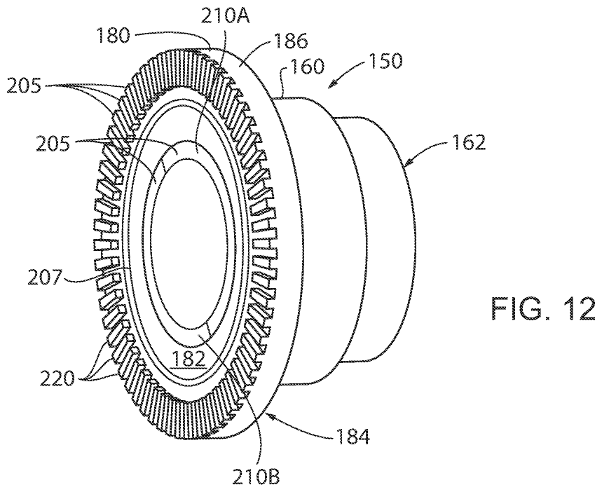

Turning next to FIG. 12, another embodiment of the hub 150 is illustrated. The hub 150 shown in FIG. 12 includes the first magnet 210A and second magnet 210B as well as the sensor teeth 220 discussed above with respect to the embodiment illustrated in FIG. 11. In addition, the sensor face 180 includes a conductive ring 207 mounted on the first surface 182 of the sensor face. The conductive ring may be, for example, copper or aluminum and may be fit into a recessed groove extending along an inner periphery of the teeth 220. Optionally, the ring 207 may be adhered to the first surface 182 utilizing a suitable adhesive or overlaid, for example, with a clear epoxy. The active sensing elements 200 may include a magnet and a stationary coil as discussed above with respect to FIG. 11. As the hub 150 in FIG. 12 rotates, the variable air-gap flux resulting from the teeth 220 rotating past the magnet induces eddy currents in the conductive ring 207. The eddy currents produce a magnetic flux opposing the magnetic flux from the magnet, where the magnitude of the eddy current is proportional to the acceleration of the hub 150. The emf in the stationary coil is proportional to the flux and, consequently, is proportional to the acceleration of the hub. The emf in the stationary coil may be used to determine the angular velocity and the angular acceleration of the hub 150.

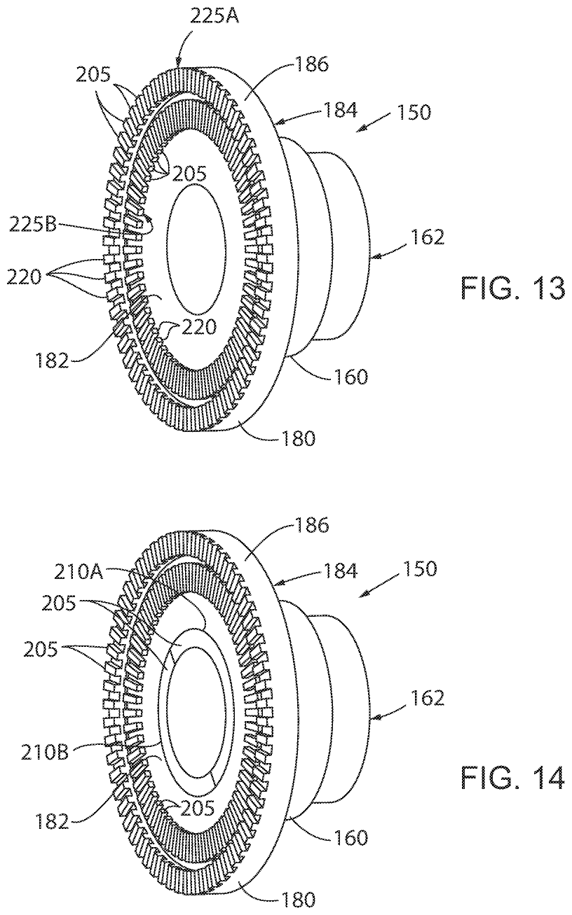

Turning next to FIG. 13, still another embodiment of the hub 150 is illustrated. The hub 150 shown in FIG. 13 includes one set of passive sensing devices 205, namely, teeth 220 spaced around the outer periphery of the first surface 182 of the sensor face 180. The teeth 220 are arranged in two, concentric rings 225 on the sensor face 180. It is contemplated that the outer ring 225A may have a different number of teeth 220 than the inner ring 225B. According to one aspect of the invention, the inner ring 225B includes one less tooth 220 than the outer ring 225A such that the teeth are arranged in a Nonius configuration. Each tooth 220 in the outer ring 225A is spaced apart a first number of degrees, and each tooth 220 in the inner ring 225B is spaced apart a second number of degrees. Use of the two rings 225 provides a more precise measurement of angular position of the motor 40 than may be achieved by a single ring. The active sensing elements 200 may include a single magnet, sized such that the magnetic field generated by the magnet interacts with both rings 225, or the active sensing elements 200 may include separate magnets for each ring 225. The active sensing elements 200 also include separate sensors to detect the interaction of the magnetic field with each ring 225 of teeth 220. Each sensor generates a position feedback signal 48 to the sensor interface 90. It is contemplated that the sensor interface 90 may perform some initial processing on the feedback signals 48 from each active sensing element 200 to combine them into a single position feedback signal. The sensor interface may then transmit the single position feedback signal to the processor 92 on the communication module 75 or the processor 132 in the distributed motor controller 31. Alternately, the sensor interface 90 may pass both position feedback signals 48 to the processor 92 on the communication module 75 or the processor 132 in a distributed motor controller 31 and the corresponding processor may combine the two position feedback signals into an angular position of the motor 40. As further shown in FIG. 14, the multiple rings 205 of teeth 220 may be used in combination with the magnets 210A, 210B discussed above.

With reference next to FIG. 15, still another embodiment of the hub 150 is illustrated. The hub 150 includes magnets 210A, 210B located around the outer periphery of the first surface 182 of the sensor face 180. The corresponding active sensing elements 200 to detect these magnets 210 may similarly be located on the substrate 77 at a position opposite the magnets 210. The hub 150 includes a second passive sensing element 205, where the second passive sensing element is a polarizing material 230 positioned over the center of the first surface 182. The active sensing element 200 corresponding to the polarizing material 230 may include a light transmitter, a light receiver, or a transceiver configured to both emit and detect light reflected from the polarizing material 230. The polarizing material 230 is configured to receive incident light on the polarizing surface, where the incident light may be non-polarized light emitted from the transmitter or transceiver on the substrate 77. The polarizing material 230 is configured to reflect at least a portion of the light incident on its surface back toward the receiver or transceiver on the substrate 77. The reflected light is polarized, meaning that the waveforms of the reflected light will be generally in a constant orientation with respect to the polarizing surface 230 and transverse between the polarizing surface 230 and a receiver mounted on the substrate 77. As the hub 150 and, consequently, the polarizing surface 230 rotates, the orientation of the reflected light similarly rotates such that the amplitude of the light waveform received at the receiver is at a maximum in one orientation, at a minimum when the hub 150 has rotated ninety degrees, and returns to a maximum again when the hub 150 has rotated one hundred eighty degrees. The receiver generates a position feedback signal 48 corresponding to the amplitude of the light received and transmits the position feedback signal to the processor 92 on the communication module 75 or the processor 132 in a distributed motor controller 31. The corresponding processor may utilize the variation in the amplitude to determine an angular position of the motor 40.

The illustrated hubs 150 are not intended to be limiting, but rather to illustrate a number of different combinations of passive sensing elements 205 that may be mounted to a hub 150. A particular combination of passive sensing elements 205 may be selected according to an application's requirements. An application requiring less resolution on the angular position may utilize just the magnets 210. An application requiring high resolution on the angular position may utilize two rings 225 of teeth 220. An application requiring redundant position feedback signals may select any two of the passive sensing elements 205, where one sensing element generates a primary position feedback signal 48 which may be utilized to control operation of the motor 40 and the other sensing element generates a secondary position feedback signal 48 which may be utilized to verify operation of the first sensing element. Various combinations of passive sensing elements 205 may be selected without deviating from the scope of the invention.

It is contemplated that the different passive sensing elements 205 may be mounted to the hub in a uniform manner such that the active sensing elements 200 may be mounted to the substrate 77 in a manner that will generate a position feedback signal 48 if the respective passive sensing elements 205 are present. A single substrate 77 may be provided which includes active sensing elements 200 for each of the different passive sensing elements 205. Optionally, a single substrate 77 may be populated with only the active sensing elements 200 required for a particular hub 150. The sensor interface 90 receivers the feedback signals 48 and provides the feedback signals to either the processor 92 on the communication module 75 or the processor 132 in a distributed motor controller 31. If the communication module 75 includes a processor 92, the processor may utilize any of the feedback signals 48 present and generate a consistent position value corresponding to the absolute position of the motor, where the position value is provided to the motor controller 30 in a uniform manner regardless of the passive sensing devices 205 present on the hub 150.

It should be understood that the invention is not limited in its application to the details of construction and arrangements of the components set forth herein. The invention is capable of other embodiments and of being practiced or carried out in various ways. Variations and modifications of the foregoing are within the scope of the present invention. It also being understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention.

In the preceding specification, various embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

We claim:

1. A modular encoder for absolute position sensing in a motor, the encoder comprising:
a hub including:
a central hub portion configured to mount to a rotor of the motor,
a sensor face connected to the central hub portion, and
at least one set of passive sensing elements mounted to the sensor face, wherein the sensor face is configured to receive a plurality of different sets of passive sensing elements; and
a sensing module mechanically and electrically isolated from the hub, the sensing module including:
a substrate configured to be mounted within an end bell of the motor, and
a plurality of active sensing elements mounted to the substrate, wherein each of the plurality of active sensing elements is configured to generate a position feedback signal responsive to detecting one of the plurality of passive sensing elements.

2. The encoder of claim 1 wherein:
the rotor includes a coupling portion extending from one end of a housing for the motor and within a volume enclosed by the end bell of the motor;
the coupling portion of the rotor includes an outer periphery configured to receive the central hub portion;
the central hub portion further includes a first side configured to receive the coupling portion of the rotor and a second side joined to the sensor face;
the first side of the central hub portion includes an opening having an inner periphery complementary to the outer periphery of the coupling portion of the rotor, such that the central hub portion slidable engages and is rigidly coupled to the coupling portion of the rotor.

3. The encoder of claim 2 wherein:
the coupling portion of the rotor includes a first keying element,
the opening of the central hub includes a second keying element,
the second keying element is complementary to and configured to engage the first keying element to define a desired orientation of the central hub when it is mounted to the coupling portion of the rotor.

4. The encoder of claim 3 wherein:
the outer periphery of the coupling portion is asymmetrical and an asymmetry of the outer periphery defines the first keying element, and
the inner periphery of the opening in the central hub is asymmetrical, corresponds to the outer periphery of the coupling portion, and an asymmetry of the inner periphery defines the second keying element.

5. The encoder of claim 3 wherein:
a first member, selected between the coupling portion of the rotor and the central hub portion, includes a protrusion extending from a surface, and
a second member, selected between the coupling portion of the rotor and the central hub portion and different than the first member, includes a recess configured to receive the protrusion of the first member.

6. The encoder of claim 1 wherein the sensor face includes a first set of passive sensing elements and a second set of passive sensing elements and wherein the sensing module includes a first active sensing element corresponding to the first set of passive sensing elements and a second active sensing element corresponding to the second set of passive sensing elements.

7. The encoder of claim 1 wherein the sensing module further includes a non-volatile, multi-turn sensing device.

8. The encoder of claim 1 wherein the active sensing elements further include a temperature sensor configured to generate a signal corresponding to a measured temperature from either the hub or the rotor.

9. The encoder of claim 1 wherein the passive sensing elements includes a plurality of teeth mounted on the sensor face and wherein each of the plurality of teeth has an asymmetric construction.

10. A method of determining an absolute position of a motor with a modular encoder, the method comprising the steps of:
mounting one of a plurality of hubs to a rotor of the motor, wherein each of the plurality of hubs includes:
a central hub portion configured to mount to the rotor,
a sensor face connected to the central hub portion, and
at least one set of passive sensing elements mounted to the sensor face, wherein the sensor face is configured to receive a plurality of different sets of passive sensing elements;
mounting a sensing module within an end bell of the motor, wherein:
the sensing module is mechanically and electrically isolated from the hub,
the sensing module includes a substrate and a plurality of active sensing elements mounted to the substrate, and
each of the plurality of active sensing elements is configured to generate a position feedback signal responsive to detecting one of the plurality of passive sensing elements; and
sampling the position feedback signal from at least one of the plurality of active sensing elements to determine the absolute position of the motor.

11. An encoder for absolute position sensing in a motor, the encoder comprising:
a hub including:
a central hub portion configured to mount to a rotor of the motor,
a sensor face connected to the central hub portion, and
at least one set of passive sensing elements mounted to the sensor face, wherein the sensor face is configured to receive a plurality of different sets of passive sensing elements;
a plurality of active sensing elements mounted within an end bell of the motor, wherein each of the plurality of active sensing elements is mechanically and electrically isolated from the hub and is configured to generate a position feedback signal responsive to detecting one of the plurality of passive sensing elements; and
a processor configured to control operation of the motor, wherein the processor is further configured to sample the position feedback signal from each of the plurality of active sensing elements to determine an absolute position of the motor.

12. The encoder of claim 11 further comprising:
a first substrate configured to be mounted within the end bell of the motor, wherein the plurality of active sensing elements are mounted on the first substrate; and
a second substrate configured to be mounted either within the end bell of the motor or within another housing mounted to the motor, wherein the processor is mounted on the second substrate.

13. The encoder of claim 11 further comprising a substrate configured to be mounted within the end bell of the motor, wherein the plurality of active sensing elements and the processor are each mounted to the substrate.

14. The encoder of claim 11 wherein:
the rotor includes a coupling portion extending from one end of a housing for the motor and within a volume enclosed by the end bell of the motor;
the coupling portion of the rotor includes an outer periphery configured to receive the central hub portion;
the central hub portion further includes a first side configured to receive the coupling portion of the rotor and a second side joined to the sensor face;
the first side of the central hub portion includes an opening having an inner periphery complementary to the outer periphery of the coupling portion of the rotor, such that the central hub portion slidable engages and is rigidly coupled to the coupling portion of the rotor.

15. The encoder of claim 14 wherein:
the coupling portion of the rotor includes a first keying element,
the opening of the central hub includes a second keying element,
the second keying element is complementary to and configured to engage the first keying element to define a desired orientation of the central hub when it is mounted to the coupling portion of the rotor.

16. The encoder of claim 15 wherein:
the outer periphery of the coupling portion is asymmetrical and an asymmetry of the outer periphery defines the first keying element, and
the inner periphery of the opening in the central hub is asymmetrical, corresponds to the outer periphery of the coupling portion, and an asymmetry of the inner periphery defines the second keying element.

17. The encoder of claim 15 wherein:
a first member, selected between the coupling portion of the rotor and the central hub portion, includes a protrusion extending from a surface, and
a second member, selected between the coupling portion of the rotor and the central hub portion and different than the first member, includes a recess configured to receive the protrusion of the first member.

18. The encoder of claim 11 wherein the Plurality of active sensing elements further includes a temperature sensor configured to generate a signal corresponding to a measured temperature from either the hub or the rotor.

19. The encoder of claim 18 wherein the sensing module further includes a non-volatile, multi-turn sensing device.

20. The encoder of claim 11 wherein the passive sensing elements are selected from one of a set of magnets, a plurality of teeth, and a polarizing material.
